(19) United States
(12) Patent Application Publication
(10) Pub. No.: US 2018/0261398 A1
(43) Pub. Date: Sep. 13, 2018

(54) PHOTOELECTRIC CONVERSION ELEMENT AND PHOTOELECTRIC CONVERSION MODULE

(71) Applicant: SHARP KABUSHIKI KAISHA, Sakai City, Osaka (JP)

(72) Inventors: HIROKAZU ICHINOSE, Sakai City (JP); TOMOHISA YOSHIE, Sakai City (JP); NORIO MUROFUSHI, Sakai City (JP)

(73) Assignees: SHARP KABUSHIKI KAISHA, Sakai City, Osaka (JP); SHARP KABUSHIKI KAISHA, Sakai City, Osaka (JP)

(21) Appl. No.: 15/761,423

(22) PCT Filed: Sep. 21, 2016
(86) PCT No.: PCT/JP2016/077792

§ 371 Date: Mar. 19, 2018

(30) Foreign Application Priority Data
Sep. 25, 2015 (JP) 2015-187988

(51) Int. Cl. H01G 9/20; H01G 9/00

(52) U.S. Cl. CPC H01G 9/2031; H01G 9/209; H01G 9/2018; H01G 9/0029; H01G 9/2059; H01G 9/2077

(57) ABSTRACT

A photoelectric conversion element includes a first substrate, a second substrate, a first conductive layer, a photoelectric conversion layer, a porous insulating layer, a second conductive layer, a sealing member, and an electrolyte. The photoelectric conversion layer includes a porous semiconductor layer and a photosensitizer added to the porous semiconductor layer. The first conductive layer is divided by a groove into a first region where the photoelectric conversion layer is arranged, and a second region where the photoelectric conversion layer is not arranged. An insulating portion is arranged in and above the groove in a covering relation to a surface of the first region in part thereof where the photoelectric conversion layer is not arranged. The insulating portion has a denser structure than the porous insulating layer. When the photoelectric conversion layer and the insulating portion are projected onto a plane parallel to the first substrate from the side including the second substrate, a projection image of the insulating portion partly overlaps a projection image of the photoelectric conversion layer.

### TECHNICAL FIELD

The present invention relates to a photoelectric conversion element and a photoelectric conversion module. This application is based on and claims priority of the prior Japanese Patent Application No. 2015-187988, filed on Sep. 25, 2015, the entire contents of which are incorporated herein by reference.

### BACKGROUND ART

Attention has been focused on sunlight as energy source to be replaced with fossil fuel, and on a solar cell capable of converting sunlight to electric power. In particular, a dye-sensitized solar cell has received attention as a new type solar cell because of advantages such as enabling reduction of the production cost.

For instance, Patent Literature (PTL) 1 discloses a dye-sensitized solar cell of a monolithic structure. In the monolithic structure, as illustrated in FIG. 12, a first conductive layer 3, a photoelectric conversion layer 4, a porous insulating layer 5, a catalyst layer 6, and a second conductive layer 7 are laminated, and a second substrate 2 is arranged with a space formed relative to the second conductive layer 7. The disclosed monolithic structure has a problem that internal short-circuiting may occur with conductive particles, i.e., materials of the second conductive layer 7, passing through pores in the porous insulating layer 5 and coming into the first conductive layer 3.

On the other hand, PTL 2 discloses a dye-sensitized solar cell of a monolithic structure in which a first dense photoelectrode 34 is arranged between a transparent conductive film 32 (corresponding to the first conductive layer 3 in FIG. 13) and a second photoelectrode 35 (corresponding to the photoelectric conversion layer 4 in FIG. 13). PTL 2 states that, with the presence of the first dense photoelectrode 34, conductive particles are suppressed from coming into the transparent conductive film 32.

### CITATION LIST

### Patent Literature

PTL 1: Japanese Unexamined Patent Application Publication No. 2009-146625

PTL 2: Japanese Unexamined Patent Application Publication No. 2002-367686

### SUMMARY OF INVENTION

### Technical Problem

In the dye-sensitized solar cell disclosed in PTL 2, however, the transparent conductive film 32 positioned at or near a scribe 33 is covered just with a porous separator 36. Therefore, the above-described internal short-circuiting is not sufficiently suppressed in the state of the art.

### Solution to Problem

One embodiment disclosed herein provides a photoelectric conversion element including a first substrate, a second substrate opposing to the first substrate with a space formed therebetween, a first conductive layer positioned on the first substrate, a photoelectric conversion layer positioned on the first conductive layer, a porous insulating layer positioned on the photoelectric conversion layer, a second conductive layer positioned on the porous insulating layer, a sealing member surrounding a region between the first substrate and the second substrate, and an electrolyte filled into the region surrounded by the first substrate, the second substrate, and the sealing member, wherein the photoelectric conversion layer includes a porous semiconductor layer and a photosensitizer added to the porous semiconductor layer, the first conductive layer is divided by a groove into a first region where the photoelectric conversion layer is arranged, and a second region where the photoelectric conversion layer is not arranged, an insulating portion is arranged in and above in a covering relation to a surface of the first region in part thereof where the photoelectric conversion layer is not arranged, the insulating portion has a denser structure than the porous insulating layer, and when the photoelectric conversion layer and the insulating portion are projected onto the first substrate from the side including the second substrate, a projection image of the insulating portion partly overlaps a projection image of the photoelectric conversion layer.

Another embodiment disclosed herein provides a photoelectric conversion module including the above-described photoelectric conversion element.

### Advantageous Effects of Invention

According to the embodiments disclosed herein, internal short-circuiting in the photoelectric conversion element and the photoelectric conversion module can be suppressed.

### BRIEF DESCRIPTION OF DRAWINGS

FIG. 1 is a schematic sectional view of a photoelectric conversion element of Embodiment 1.

FIG. 2 is a schematic plan view illustrating projection images when a photoelectric conversion layer and an insulating portion are projected onto a first substrate from the second substrate side in the photoelectric conversion element of Embodiment 1.

FIG. 3 is a flowchart illustrating an example of a manufacturing method for the photoelectric conversion element of Embodiment 1.

FIG. 4 is a schematic sectional view illustrating part of manufacturing steps in the example of the manufacturing method for the photoelectric conversion element of Embodiment 1.

FIG. 5 is a schematic sectional view illustrating part of the manufacturing steps in the example of the manufacturing method for the photoelectric conversion element of Embodiment 1.

FIG. 6 is a schematic sectional view illustrating part of the manufacturing steps in the example of the manufacturing method for the photoelectric conversion element of Embodiment 1.

FIG. 7 is a schematic sectional view of illustrating part of the manufacturing steps in the example of the manufacturing method for the photoelectric conversion element of Embodiment 1.

FIG. 8 is a schematic sectional view illustrating part of the manufacturing steps in the example of the manufacturing method for the photoelectric conversion element of Embodiment 1.

FIG. 9 is a schematic sectional view illustrating part of the manufacturing steps in the example of the manufacturing method for the photoelectric conversion element of Embodiment 1.

FIG. 10 is a schematic sectional view of illustrating part of the manufacturing steps in the example of the manufacturing method for the photoelectric conversion element of Embodiment 1.

FIG. 11 is a schematic sectional view illustrating part of the manufacturing steps in the example of the manufacturing method for the photoelectric conversion element of Embodiment 1.

FIG. 12 is a schematic sectional view of a photoelectric conversion element of related art.

FIG. 13 is a schematic view illustrating a propagation direction of light traveling toward the insulating portion from the photoelectric conversion layer in the photoelectric conversion element of Embodiment 1.

FIG. 14 is a schematic sectional view of a photoelectric conversion element of Embodiment 2.

FIG. 15 is a schematic view illustrating refraction of light traveling toward the insulating portion from the photoelectric conversion layer in the photoelectric conversion element of Embodiment 2.

FIG. 16 is a schematic sectional view of a photoelectric conversion element of Embodiment 3.

FIG. 17 is a schematic sectional view of a photoelectric conversion element of Embodiment 4.

FIG. 18 is a schematic plan view illustrating projection images when a photoelectric conversion layer and an insulating portion are projected onto a first substrate from the second substrate side in the photoelectric conversion element of Embodiment 4.

FIG. 19 is a schematic sectional view of a photoelectric conversion element of Embodiment 5.

FIG. 20 is a schematic sectional view of a photoelectric conversion element of Embodiment 6.

FIG. 21 is a schematic sectional view of a photoelectric conversion module of Embodiment 7.

### DESCRIPTION OF EMBODIMENTS

Embodiments will be described below. In the drawings referenced to explain the embodiments, the same reference signs represent the same components or corresponding components. In this Description, the expression “X to Y” implies upper and lower limits of a range (i.e., not less than X and not more than Y). When a unit is not denoted for X and a unit is denoted only for Y, the unit of X and the unit of Y are the same.

### Embodiment 1

### <Structure of Photoelectric Conversion Element>

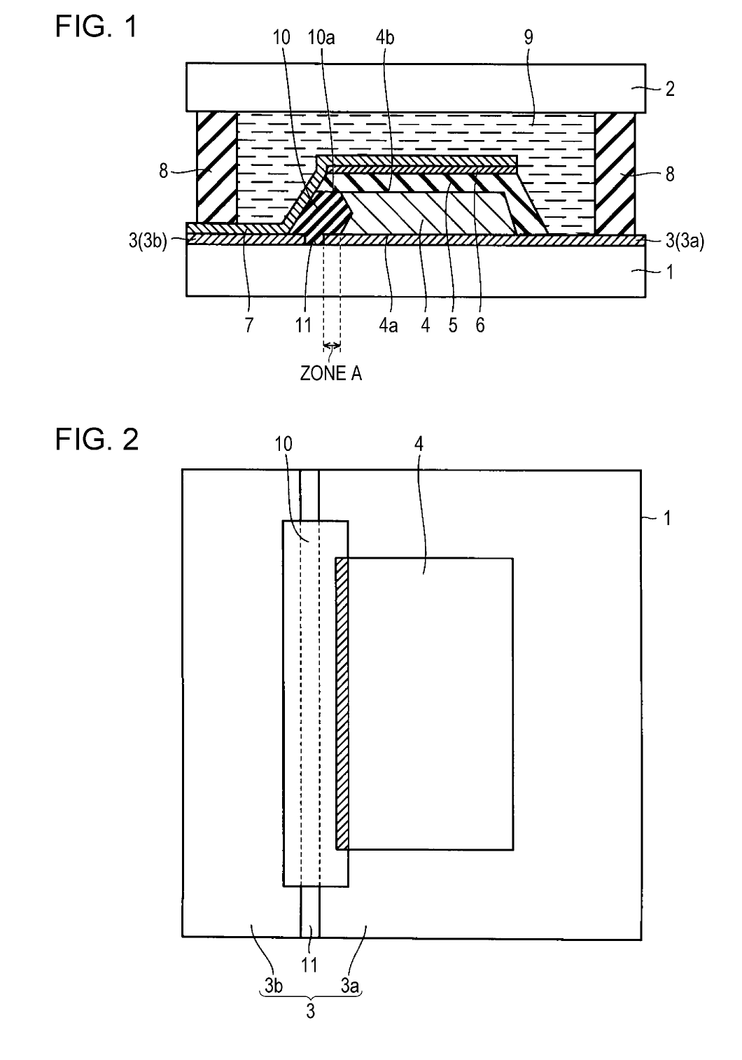

A structure of a photoelectric conversion element of Embodiment 1 is described below with reference to FIGS. 1 and 2. The photoelectric conversion element of Embodiment 1 includes a first substrate 1, a second substrate 2 opposing to the first substrate 1 with a space formed relative to the first substrate 1, a first conductive layer 3 positioned on the first substrate 1, a photoelectric conversion layer 4 positioned on the first conductive layer 3, a porous insulating layer 5 positioned on the photoelectric conversion layer 4, and a second conductive layer 7 positioned on the porous insulating layer 5. A catalyst layer 6 is arranged in at least part of a region between the porous insulating layer 5 and the second conductive layer 7. The first substrate 1 and the second substrate 2 are joined to each other by a sealing member 8, and an electrolyte 9 is arranged in a region surrounded by the first substrate 1, the second substrate 2, and the sealing member 8.

The first conductive layer 3 is divided by a groove (scribe line) 11 into a first region 3a where the photoelectric conversion layer 4 is arranged, and a second region 3b where the photoelectric conversion layer 4 is not arranged. An insulating portion 10 is arranged in the groove 11. Configurations, materials, etc. of the above-mentioned individual components are described in detail below.

(First Substrate)

A transparent substrate having optical transparency can be used as the first substrate 1. However, the first substrate 1 is just needed to be made of, for example, a material allowing substantial transmission of light with a wavelength for which a later-described photosensitizer has effective sensitivity, and it is not always needed to have transparency to light in an overall wavelength range. More specifically, a glass substrate made of soda-lime glass, fused quart glass, or crystalline quartz glass, or a heat-resistant resin plate, such as a flexible film, may be used. A thickness of the first substrate 1 is preferably 0.2 to 5 mm (i.e., not less than 0.2 mm and not more than 5 mm).

(Second Substrate)

The second substrate 2 is not limited to particular one, and it may have or not have optical transparency. A substrate made of ordinary glass, for example, can be used as the substrate having optical transparency. From the viewpoint of reducing the weight, a substrate made of alkali glass is preferably used.

(First Conductive Layer)

The first conductive layer 3 is disposed on a surface of the first substrate 1, the surface opposing to the second substrate 2. The first conductive layer 3 is divided by the groove 11 into the first region 3a where the photoelectric conversion layer 4 is arranged, and the second region 3b where the photoelectric conversion layer 4 is not arranged.

More specifically, however, the photoelectric conversion layer 4 is not arranged on the first region 3a at its end portion delimiting the groove 11 (i.e., on part of the first region 3a, the part being positioned in a zone A). Furthermore, the photoelectric conversion layer 4 is not arranged on an end portion of the first region 3a on the side opposite to the zone A. The second conductive layer 7 is arranged on the second region 3b.

A material of the first conductive layer 3 is not limited to particular one insofar as having electrical conductivity and optical transparency. For example, at least one selected from a group consisting of indium tin oxide (ITO), tin oxide (SnO₂), fluorine-doped tin oxide (i.e., FTO), and zinc oxide (ZnO) can be used. A thickness of the first conductive layer 3 is preferably 0.02 to 5 μm. An electrical resistance of the first conductive layer 3 is preferably as low as possible, and it is preferably not more than 40 Ω/sq.

(Photoelectric Conversion Layer)

The photoelectric conversion layer 4 is disposed on an upper surface (as viewed in FIG. 1) of the first region 3a of the first conductive layer 3, and a surface of the photoelectric conversion layer 4 is covered with the porous insulating layer 5 and the insulating portion 10. The photoelectric conversion layer 4 has a first surface 4a opposing to the first substrate 1, and a second surface 4b opposing to the second substrate 2. One side of the photoelectric conversion layer 4, the one side being substantially parallel to the groove 11 and positioned near the groove 11, has a shape recessed toward the center side of the photoelectric conversion layer 4.

In this Description, the center side of the photoelectric conversion layer 4 implies a central portion of the photoelectric conversion layer 4 extending in the left-right direction in FIG. 1, and the end side of the photoelectric conversion layer 4 implies both end portions of the photoelectric conversion layer 4 extending in the left-right direction in FIG. 1.

The photoelectric conversion layer 4 having the above-described shape is constituted by a porous semiconductor layer disposed as a base on the first conductive layer 3, and by a photosensitizer put on surfaces inside and outside pores in the porous semiconductor layer.

A material of the porous semiconductor layer is not limited to particular one insofar as it is generally used as a photoelectric conversion material. The porous semiconductor layer can be made of at least one selected from a group consisting of, for example, titanium oxide, zinc oxide, tin oxide, iron oxide, niobium oxide, cerium oxide, tungsten oxide, barium titanate, strontium titanate, cadmium sulfide, lead sulfide, zinc sulfide, indium phosphide, copper-indium sulfide (CuInS₂), CuAlO₂, and SrCu₂O₂. Among the above-mentioned porous semiconductors, titanium oxide is preferable because of having high stability.

A thickness of the porous semiconductor layer is not limited to a particular value, but it may be 0.1 to 100 μm, for example. A surface area of the porous semiconductor layer is preferably 10 to 200 m²/g.

A sensitizer dye, such as an organic dye or a metal complex dye, can be used as the photosensitizer. The organic dye may be at least one selected from a group consisting of, for example, an azo dye, a quinone dye, a quinone imine dye, a quinacridone dye, a squarylium dye, a cyanine dye, a merocyanine dye, a triphenylmethane dye, a xanthene dye, a porphyrin dye, a perylene dye, an indigo dye, and a naphthalocyanine dye. An absorptivity of the organic dye is generally greater than that of the metal complex dye in which a molecule is coordinately bonded to a transition metal.

The metal complex dye is in the form where a metal is coordinately bonded to a molecule. The molecule may be given by a porphyrin dye, a phthalocyanine dye, a naphthalocyanine dye, or a ruthenium dye. The metal may be at least one selected from a group consisting of, for example, Cu, Ni, Fe, Co, V, Sn, Si, Ti, Ge, Cr, Zn, Ru, Mg, Al, Pb, Mn, In, Mo, Y, Zr, Nb, Sb, La, W, Pt, TA, Ir, Pd, Os, Ga, Tb, Eu, Rb, Bi, Se, As, Sc, Ag, Cd, Hf, Re, Au, Ac, Tc, Te, and Rh. Above all, the metal complex dye is preferably in the form where the metal is coordinately bonded to phthalocyanine dye or the ruthenium dye. Using the ruthenium metal complex dye is particularly preferable.

The ruthenium metal complex dye may be a commercially-available ruthenium metal complex dye, such as Ruthenium 535 dye, Ruthenium 535-bisTBA dye, or Ruthenium 620-1H3TBA dye all made by Solaronix Co.

(Porous Insulating Layer)

The porous insulating layer 5 is disposed on the photoelectric conversion layer 4. The porous insulating layer 5 may be at least one selected from a group consisting of, for example, titanium oxide, niobium oxide, zirconium oxide, silicon oxide such as silica glass or soda-lime glass, aluminum oxide, and barium titanate.

(Catalyst Layer)

The catalyst layer 6 is disposed on a surface of the porous insulating layer 5, the surface opposing to the second substrate 2. The catalyst layer 6 may be at least one selected from a group consisting of, for example, platinum, carbon black, Ketjen black, carbon nanotube, and fullerene.

(Second Conductive Layer)

One end of the second conductive layer 7 is electrically connected to the second region 3b of the first conductive layer 3. The other end of the second conductive layer 7 is electrically connected to the catalyst layer 6. A material of the second conductive layer 7 is not limited to particular one insofar as having electrical conductivity. For example, the same material as that of the first conductive layer 3 may be used. A thickness of the second conductive layer 7 is preferably 0.02 to 5 μm. An electrical resistance of the second conductive layer 7 is preferably as low as possible, and it is preferably not more than 40 Ω/sq.

(Insulating Portion)

The insulating portion 10 is disposed in and above the groove 11, and covers at least part of a surface of the first region 3a where the photoelectric conversion layer 4 is not arranged. Preferably, the insulating portion 10 further covers the first substrate 1 at the surface positioned between the first region 3a and the second region 3b.

A surface of the insulating portion 10, the surface contacting a recessed surface of the photoelectric conversion layer 4, has a convex shape projecting outward corresponding to the recessed surface of the photoelectric conversion layer 4. Thus, the insulating portion 10 is positioned in a state of biting into the photoelectric conversion layer 4 toward the center side.

Furthermore, as illustrated in FIG. 2, when the photoelectric conversion layer 4 and the insulating portion 10 are projected onto the first substrate 1 from the side including the second substrate 2, a projection image of the insulating portion 10 partly overlaps a projection image of the photoelectric conversion layer 4. In FIG. 2, a hatched region denotes an overlapped region between the projection image of the insulating portion 10 and the projection image of the photoelectric conversion layer 4.

The insulating portion 10 has a denser structure than the porous insulating layer 5. This implies that, while the porous insulating layer 5 has a structure allowing conductive particles to pass therethrough (i.e., a porous structure), the insulating portion 10 has a relatively dense structure not allowing the conductive particles to pass therethrough. In other words, the insulating portion 10 has a smaller void ratio than the porous insulating layer 5. While the void ratio of the porous insulating layer 5 is generally about 60%, the void ratio of the insulating portion 10 is preferably 0 to 50% and more preferably 0 to 10%. Moreover, a void size of the insulating portion 10 is preferably smaller than that of the porous insulating layer 5. The insulating portion 10 having the above-described properties may be made of, for example, a silicone resin, an epoxy resin, a polyisobutylene resin, a hot-melt resin, or a glass frit. Above all, glass frit is preferably used from the viewpoint of heat resistance and chemical resistance.

(Sealing Member)

The sealing member 8 serves to hold the first substrate 1 and the second substrate 2 in an opposing relation with a space formed therebetween. More specifically, the sealing member 8 bonds the second substrate 2 to the first conductive layer 3 (in the first region 3a) and further bonds the second substrate 2 to the second conductive layer 7, thereby bonding the first substrate 1 and the second substrate 2 to each other. Thus, the region surrounded by the first substrate 1, the second substrate 2, and the sealing member 8 is sealed off.

The sealing member 8 is just needed to have insulation properties, and is preferably made of, for example, a ultraviolet curable resin or a thermosetting resin from the viewpoint of easiness in manufacturing. More specifically, the sealing member 8 is made of, for example, a silicone resin, an epoxy resin, a polyisobutylene resin, a hot-melt resin, or a glass frit.

(Electrolyte)

The electrolyte 9 is filled in the region surrounded by the first substrate 1, the second substrate 2, and the sealing member 8. An electrolyte having at least fluidity can be used as the electrolyte 9. For example, a liquid electrolyte, such as an electrolyte solution, can be preferably used. The liquid electrolyte is just needed to be a liquid material containing redox species. For example, a liquid electrolyte made up of redox species and a solvent capable of dissolving the redox species can be used.

The redox species may be of, for example, I⁻/I³⁻ series, Br²⁻/Br³⁻ series, Fe²⁺/Fe³⁺ series, or quinone/hydroquinone series. More specifically, the redox species may be a combination of a metal iodide, such as lithium iodide (LiI), sodium iodide (NaI), or potassium iodide (KI), calcium iodide (CaI₂), and iodine (I₂). Furthermore, the redox species may be a combination of a tetraalkylammonium salt, such as tetraethylammonium iodide (TEAI), tetrapropylammonium iodide (TPAI), tetrabutylammonium iodide (TBAI), or tetrahexylammonium iodide (THAI), and iodine. Moreover, the redox species may be a combination of a metal bromide, such as lithium bromide (LiBr), sodium bromide (NaBr), potassium bromide (KBr), or calcium bromide (CaBr₂), and bromine. Above all, the combination of LiI and I₂ is particularly preferably used as the redox species.

The solvent for the redox species is preferably a solvent containing at least one selected from a group consisting of, for example, carbonate compounds such as propylene carbonate, nitrile compounds such as acetonitrile, alcohols such as ethanol, water, and non-proton polar substances. Above all, it is preferable to use a polycarbonate compound or a nitrile compound alone, or both of them in the mixed form.

In FIG. 1, the electrolyte 9 is illustrated as being present only in part of the above-mentioned sealed-off region where no components are arranged. However, the photoelectric conversion layer 4, the porous insulating layer 5, the catalyst layer 6, and the second conductive layer 7 each include many pores, and the electrolyte 9 is present inside those pores as well.

<Manufacturing Method of Photoelectric Conversion Element>

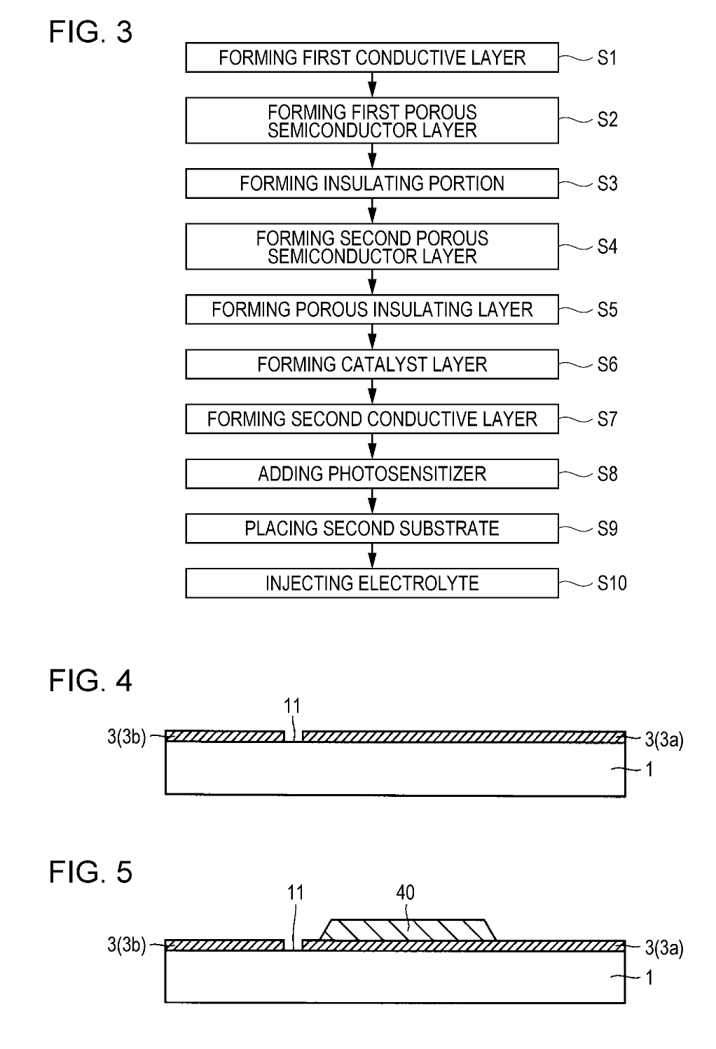

As illustrated in FIG. 3, a manufacturing method for the photoelectric conversion element of Embodiment 1 includes a step (S1) of forming the first conductive layer, a step (S2) of forming a first porous semiconductor layer, a step (S3) of forming the insulating portion, a step (S4) of forming a second porous semiconductor layer, a step (S5) of forming the porous insulating layer, a step (S6) of forming the catalyst layer, a step (S7) of forming the second conductive layer (S7), a step (S8) of adding the photosensitizer, a step (S9) of placing the second substrate, and a step (S10) of injecting the electrolyte).

An example of the manufacturing method for the photoelectric conversion element of Embodiment 1 will be described below with reference to FIGS. 1 and 3 to 11. As a matter of course, the manufacturing method for the photoelectric conversion element of Embodiment 1 may further include other steps than S1 to S10, and the sequence of the steps is not limited to that explained below.

(Step of Forming First Conductive Layer)

First, as illustrated in FIGS. 3 and 4, the first conductive layer 3 is formed on the first substrate 1 (Step S1). One layer (conductive-layer formation layer) made of the material of the first conductive layer 3 is formed on the first substrate 1 by sputtering, spraying, or screen printing, for example. Part of the conductive-layer formation layer in a region corresponding to the groove 11 is removed by irradiation of a laser beam, for example. Thus, the first conductive layer 3 divided into the first region 3a and the second region 3b by the groove 11 is formed. Alternatively, a substrate including the first conductive layer 3 previously formed thereon in a state divided into the first region 3a and the second region 3b may be disposed on the first substrate 1.

(Step of Forming First Porous Semiconductor Layer)

Next, as illustrated in FIGS. 3 and 5, a first porous semiconductor layer 40 is formed on the first conductive layer 3 (Step S2). A method of forming the first porous semiconductor layer 40 is not limited to particular one, and known related-art methods may be used optionally. For example, a method of coating a suspension liquid containing semiconductor particles over the first conductive layer 3 (in the first region 3a), and performing at least one of drying and firing of the coated suspension liquid may be used.

(Step of Forming Insulating Portion)

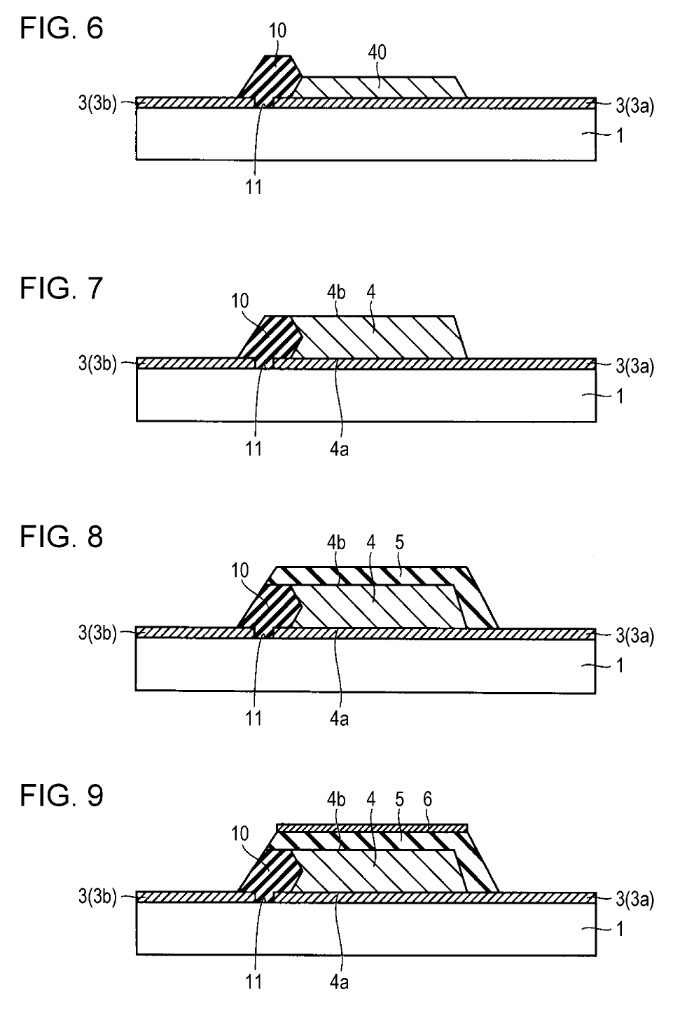

Next, as illustrated in FIGS. 3 and 6, the insulating portion 10 is formed. (Step S3). A method of forming the insulating portion 10 is not limited to particular one, and known related-art methods may be used optionally. For example, a method of coating a glass-frit containing glass plate, which is the material of the insulating portion 10, at a predetermined position by screen printing, and drying the coated glass paste.

(Step of Forming Second Porous Semiconductor Layer)

Next, as illustrated in FIGS. 3 and 7, a second porous semiconductor layer is formed on the first porous semiconductor layer 40 (Step S4). The second porous semiconductor layer can be formed in a similar manner to that of forming the first porous semiconductor layer 40. Thus, the porous semiconductor layer serving as the base of the photoelectric conversion layer 4 is formed.

(Step of Forming Porous Insulating Layer)

Next, as illustrated in FIGS. 3 and 8, the porous insulating layer 5 is formed (Step S5). A method of forming the porous insulating layer 5 is not limited to particular one, and it may be formed by a similar method to that of forming the porous semiconductor layer.

(Step of Forming Catalyst Layer)

Next, as illustrated in FIGS. 3 and 9, the catalyst layer 6 is formed (Step S6). A method of forming the catalyst layer 6 is not limited to particular one, and known related-art methods may be used optionally.

(Step of Forming Second Conductive Layer)

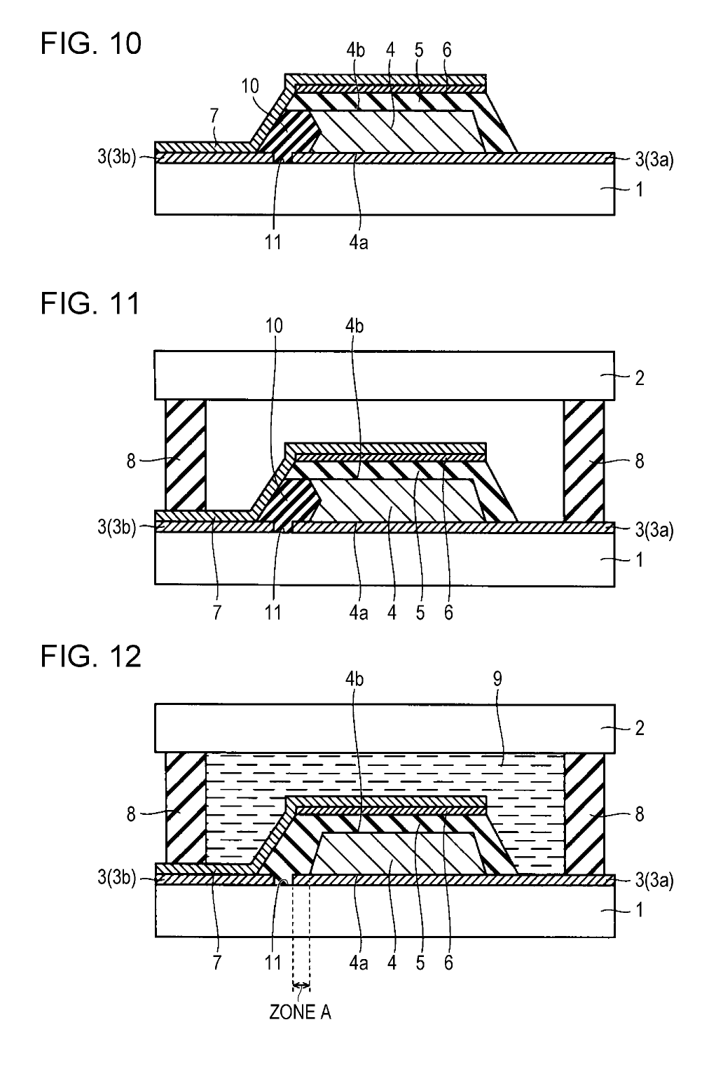

Next, as illustrated in FIGS. 3 and 10, the second conductive layer 7 is formed. (Step S7). A method of forming the second conductive layer 7 is not limited to particular one, and known related-art methods may be used optionally.

(Step of Adding Photosensitizer)

Next, as illustrated in FIG. 3, the photosensitizer is added to the porous semiconductor layer (Step S8). More specifically, the photoelectric conversion layer 4 including the photosensitizer added to the porous semiconductor layer can be formed by adsorbing the sensitizer dye as the photosensitizer on and in the porous semiconductor layer.

The sensitizer dye can be adsorbed on and in the porous semiconductor layer, for example, by a method of immersing the porous semiconductor layer in a solution for the dye adsorption in which the sensitizer dye is dissolved. When immersing the porous semiconductor layer in the solution for the dye adsorption in which the sensitizer dye is dissolved, the solution for the dye adsorption may be heated to make the solution for the dye adsorption permeated up to innermost portions of the pores in the porous semiconductor layer.

(Step of Placing Second Substrate)

Next, as illustrated in FIGS. 3 and 11, the second substrate 2 is placed above the first substrate 1 (Step S9).

First, a precursor of the sealing member 8 is coated around the photoelectric conversion layer 4 with a distance kept from an outer edge of the photoelectric conversion layer 4. A method of coating the precursor of the sealing member 8 is not limited to particular one, and the precursor may be coated over the first conductive layer 3 and the second conductive layer 7 by employing a dispenser, for example. In this Description, the precursor of the sealing member 8 implies resin before being solidified, and the sealing member 8 implies the resin after being solidified.

Then, the second substrate 2 is placed on the precursor of the sealing member 8 in an opposing relation to the first substrate 1. Thereafter, the precursor of the sealing member 8 is irradiated with ultraviolet rays, or heated. As a result, the precursor of the sealing member 8 is solidified and the sealing member 8 is formed, whereby the first substrate 1 and the second substrate 2 are bonded to each other.

(Step of Injecting Electrolyte)

Next, as illustrated in FIG. 3, the electrolyte 9 is injected into the region surrounded by the first substrate 1, the second substrate 2, and the sealing member 8 (Step S10). The electrolyte 9 may be injected, for example, by a method of forming, in the second substrate 2, a hole for injection of the electrolyte 9, and injecting the electrolyte 9 through the hole. The photoelectric conversion element of Embodiment 1 can be manufactured through the above-described steps.

<Functional Effect>

The functional effect of Embodiment 1 is described in comparison with the related-art photoelectric conversion element illustrated in FIG. 12.

In the related-art photoelectric conversion element, as illustrated in FIG. 12, the inner surface of the groove 11 and part of the surface of the first region 3a, the part being positioned in the zone A, are covered with the porous insulating layer 5. Therefore, internal short-circuiting between the first region 3a and the second region 3b and internal short-circuiting between the first region 3a and the second conductive layer 7 are suppressed.

Because of the porous insulating layer 5 having porous properties, however, conductive particles may pass through the porous insulating layer 5 and may come into the part of the first region 3a, which is positioned in the zone A, depending on conditions of the pores in the porous insulating layer 5, etc. In particular, the porous insulating layer 5 in and near the zone A has a complicated shape such as including a level difference, and hence tends to generate a shape failure. Such a shape failure may cause the internal short-circuiting in the photoelectric conversion element.

Although the photoelectric conversion element is manufactured by successively arranging individual components on a substrate with various methods, such as sputtering, spraying, and screen printing, it may occur that the part of the first region 3a positioned in the zone A is not covered with the porous insulating layer 5, when the porous insulating layer 5 is arranged apart from the predetermined position. That photoelectric conversion element becomes a defective product causing the internal short-circuiting.

On the other hand, in the photoelectric conversion element of Embodiment 1, as illustrated in FIG. 1, the insulating portion 10 covering the first region 3a in the part positioned in the zone A is arranged in the groove 11, and the insulating portion 10 has the denser structure than the porous insulating layer 5. Thus, the part of the first region 3a positioned in the zone A where the internal short-circuiting tends to occur can be covered with the dense insulating portion 10.

Furthermore, in the photoelectric conversion element of Embodiment 1, as illustrated in FIG. 2, when the photoelectric conversion layer 4 and the insulating portion 10 are projected onto the first substrate 1 from the side including the second substrate 2, the projection image of the insulating portion 10 partly overlaps the projection image of the photoelectric conversion layer 4. In other words, when looking the individual components from above in a direction perpendicular to a principal surface (surface on which the individual components are arranged) of the first substrate 1 (from the second substrate side), the insulating portion 10 bites into the region where the photoelectric conversion layer 4 is arranged. Therefore, even when layouts of the individual components are somewhat misaligned in the manufacturing steps, the part of the first region 3a positioned in the zone A can be suppressed from being exposed (namely, from being brought into a state not covered with the insulating portion 10).

Thus, according to the photoelectric conversion element of Embodiment 1, with the presence of the insulating portion 10, it is possible to suppress the conductive particles from coming into the first region 3a where the photoelectric conversion layer 4 is not arranged, and to suppress the internal short-circuiting.

In Embodiment 1, the region where the projection image of the insulating portion 10 and the projection image of the photoelectric conversion layer 4 overlap, when the photoelectric conversion layer 4 and the insulating portion 10 are projected onto the first substrate 1 from the side including the second substrate 2, preferably has a width (in the left-right direction in FIG. 2) of 100 to 500 μm. By setting the width to be not less than 100 μm, a possibility of the first region 3a being exposed due to misalignment in layouts of the individual components can be reduced sufficiently. By setting the width to be not more than 500 μm, the volume of the photoelectric conversion layer 4 can be suppressed from being excessively reduced due to the layout of the insulating portion 10.

In Embodiment 1, preferably, the insulating portion 10 has a surface 10a opposing to the second substrate 2, and the surface 10a and the first surface 4a are positioned in the same plane. Stated in another way, the surface 10a and the first surface 4a are preferably flush with each other. In that case, a possibility of shape failures of the porous insulating layer 5, the second conductive layer 7, etc. can be avoided from generating due to an unwanted level difference between the insulating portion 10 and the photoelectric conversion layer 4

In Embodiment 1, as illustrated in FIG. 1, the insulating portion 10 is preferably arranged in an entire region surrounded by the groove 11, the first conductive layer 3, the photoelectric conversion layer 4, and the second conductive layer 7. In that case, the surface of the first conductive layer 3, which is positioned in and near the zone A and in which the photoelectric conversion layer 4 is not arranged, can be entirely covered with the insulating portion 10. Moreover, since the shapes of the porous insulating layer 5 and the second conductive layer 7 can be suppressed from being complicated, a possibility of shape failures of those components can be avoided.

In Embodiment 1, a refractive index n₁₀ of the insulating portion 10 is preferably smaller than a refractive index n₄ of the photoelectric conversion layer 4. In that case, photoelectric conversion efficiency can be increased. The reason is as follows.

In the photoelectric conversion element, light entering the photoelectric conversion layer 4 is absorbed by the photosensitizer in the photoelectric conversion layer 4, whereupon photoelectric conversion is caused. Therefore, the photoelectric conversion efficiency is increased to a larger extent as the light having entered the photoelectric conversion layer 4 travels (passes) over a longer distance inside the photoelectric conversion layer 4.

In the related-art photoelectric conversion element, however, the photoelectric conversion layer 4 near the zone A tends to have a smaller thickness than the central portion of the photoelectric conversion layer 4 due to the features of the manufacturing process. In FIG. 12, for example, because the photoelectric conversion layer 4 has an area gradually decreasing toward the porous insulating layer 5 from the first conductive layer 3, the thickness of the photoelectric conversion layer 4 in its end portion is smaller than in its central portion.

Accordingly, comparing light entering the end portion of the photoelectric conversion layer 4 near the zone A and light entering the central portion of the photoelectric conversion layer 4 on condition that those lights travel parallel to a thickness direction of the photoelectric conversion layer 4, a distance through which the former light travels inside the photoelectric conversion layer 4 tends to be shorter than a distance through which the latter light travels inside the photoelectric conversion layer 4.

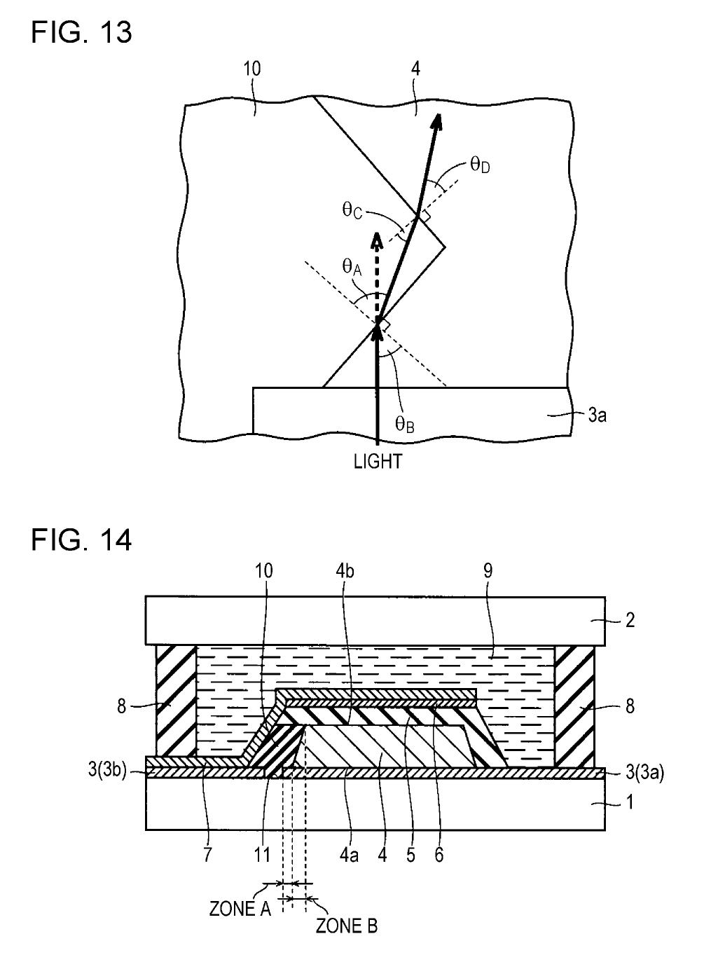

On the other hand, the photoelectric conversion element of Embodiment 1 includes the insulating portion 10 arranged in a state of biting into the photoelectric conversion layer 4 near the zone A. When (refractive index n₁₀<refractive index n₄) is satisfied in such a structure, light entering the photoelectric conversion layer 4 near the zone A is able to travel as illustrated in FIG. 13.

FIG. 13 is a schematic view illustrating a propagation direction of light traveling toward the insulating portion 10 from the photoelectric conversion layer 4 in the photoelectric conversion element of Embodiment 1. Arrows denote how the light having entered the photoelectric conversion layer 4 from the side including the first substrate 1 near the zone A travels inside the photoelectric conversion layer 4 and the insulating portion 10.

In the case of (refractive index n₁₀<refractive index n₄), as illustrated in FIG. 13, the light incident upon an interface between the photoelectric conversion layer 4 and the insulating portion 10 exits the interface at an exit angle θ_{A} larger than an incident angle θ_{B}, as denoted by a solid-line arrow, in accordance with the Snell's law. When the light having exited the above interface enters a next interface, the light exits the next interface at an exit angle θ_{D} smaller than an incident angle θ_{C} in accordance with the Snell's law. A dotted-line arrow in FIG. 13 denotes a propagation direction of the light in the case of (refractive index n₁₀=refractive index n₄).

Thus, in the case of (refractive index n₁₀<refractive index n₄) being satisfied in Embodiment 1, at time when part of the light having entered the photoelectric conversion layer 4 near the zone A passes through the interface between the photoelectric conversion layer 4 and the insulating portion 10 at least once, it is refracted toward the center side of the photoelectric conversion layer 4. The distance through which the refracted light travels inside the photoelectric conversion layer 4 is longer than the distance through which the not-refracted light travels. Accordingly, the photoelectric conversion efficiency can be increased when the photoelectric conversion element of Embodiment 1 satisfies (refractive index n₁₀<refractive index n₄).

A combination of the photoelectric conversion layer 4 and the insulating portion 10, the combination satisfying (refractive index n₁₀<refractive index n₄), is given, for example, by employing titanium oxide as the material of the porous semiconductor layer that is the base of the photoelectric conversion layer 4, and a glass paste containing a bismuth glass frit as the material of the insulating portion 10. Alternatively, a glass paste containing a phosphate glass frit may be used as the material of the insulating portion 10.

### Embodiment 2

FIG. 14 is a schematic sectional view of a photoelectric conversion element of Embodiment 2. As illustrated in FIG. 14, a zone B where the thickness of the photoelectric conversion layer 4 gradually reduces is present in the photoelectric conversion layer 4 in its part spanning from the central portion toward the end portion thereof and being closer to at least one side thereof, the one side being substantially parallel to the groove 11i. The photoelectric conversion layer 4 having such a shape can be easily formed by screen printing.

The insulating portion 10 is disposed in and above the groove 11, and covers at least part of the surface of the first region 3a where the photoelectric conversion layer 4 is not arranged. Moreover, the insulating portion 10 has a shape corresponding to a surface of the photoelectric conversion layer 4 (the surface being positioned closer to the one side thereof substantially parallel to the groove 11) in its part included in the zone B (zone including the interface between the photoelectric conversion layer 4 and the insulating portion 10). Therefore, the insulating portion 10 is arranged in a state of biting into the photoelectric conversion layer 4 toward the center side.

Because of the photoelectric conversion layer 4 and the insulating portion 10 having the above-described shapes, when the photoelectric conversion layer 4 and the insulating portion 10 are projected onto the first substrate 1 from the side including the second substrate 2, the projection image of the insulating portion 10 partly overlaps the projection image of the photoelectric conversion layer 4.

According to the photoelectric conversion element of Embodiment 2, with the presence of the insulating portion 10, it is possible to suppress the conductive particles from coming into the part of the first region 3a where the photoelectric conversion layer 4 is not arranged, and to suppress the internal short-circuiting.

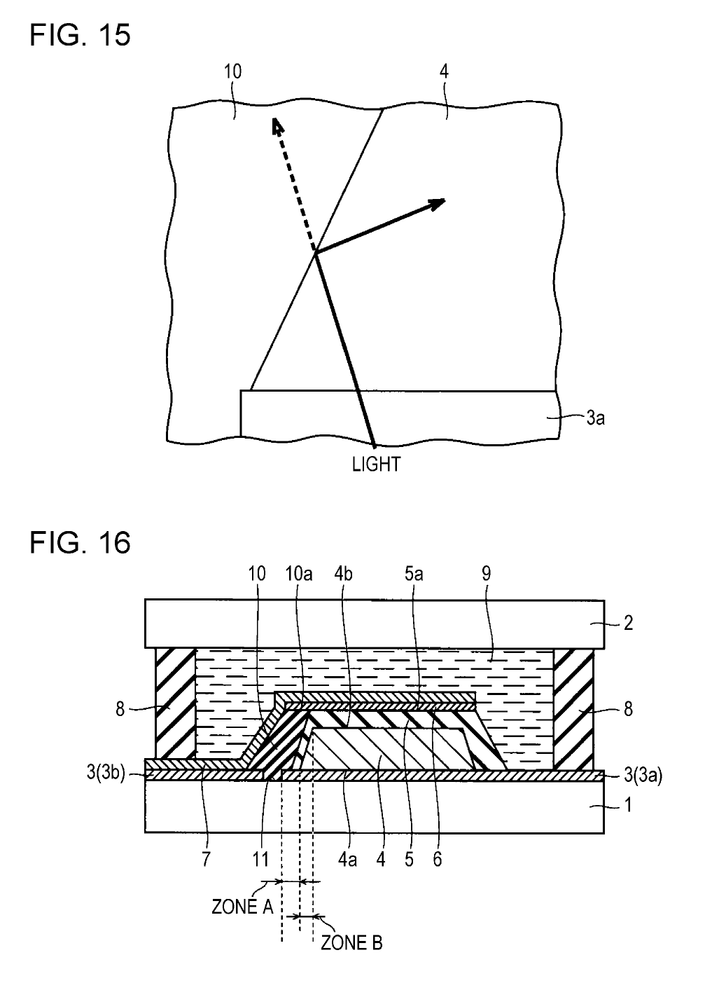

In Embodiment 2, preferably, (refractive index n₁₀<refractive index n₄) is satisfied. In that case, photoelectric conversion efficiency can be increased. The reason is described with reference to FIG. 15.

FIG. 15 is a schematic view illustrating a propagation direction of light traveling toward the insulating portion 10 from the photoelectric conversion layer 4 in the photoelectric conversion element of Embodiment 2. Arrows denote how the light having entered the photoelectric conversion layer 4 from the side including the first substrate 1 in and near the zone B travels.

In the case of (refractive index n₁₀<refractive index n₄), as illustrated in FIG. 15, part of the light incident upon the interface between the photoelectric conversion layer 4 and the insulating portion 10 is reflected at the interface and is able to travel toward the central portion of the photoelectric conversion layer 4. A dotted-line arrow in FIG. 15 denotes a propagation direction of the light in the case of (refractive index n₁₀=refractive index n₄).

Thus, in the case of (refractive index n₁₀<refractive index n₄) being satisfied in Embodiment 2, part of the light having entered the photoelectric conversion layer 4 in and near the zone B can be reflected at the interface between the photoelectric conversion layer 4 and the insulating portion 10 toward the central portion of the photoelectric conversion layer 4. A distance through which the reflected light travels inside the photoelectric conversion layer 4 is longer than a distance through which the not-reflected light travels. Accordingly, the photoelectric conversion efficiency can be increased when the photoelectric conversion element of Embodiment 2 satisfies (refractive index n₁₀<refractive index n₄).

When the porous insulating layer 5 is arranged in a region of the photoelectric conversion layer 4 closer to at least one side thereof, the one side being substantially parallel to the groove 11, instead of the insulating portion 10 as in the related art, the above-described reflection effect cannot be expected because the porous insulating layer 5 has relatively low light reflection efficiency due to porous properties.

Other points in Embodiment 2 than described above are similar to those in Embodiment 1, and hence description of those points is not repeated.

### Embodiment 3

FIG. 16 is a schematic sectional view of a photoelectric conversion element of Embodiment 3. Embodiment 3 is different from Embodiment 2 in that the porous insulating layer 5 is partly interposed between the insulating portion 10 and the photoelectric conversion layer 4. The internal short-circuiting can be suppressed in the photoelectric conversion element of Embodiment 3 as well for the same reason as that in Embodiment 1 and Embodiment 2.

In Embodiment 3, preferably, the surface 10a of the insulating portion 10 opposing to the second substrate 2 and a surface 5a of the porous insulating layer 5 opposing to the second substrate 2 are positioned in the same plane. Stated in another way, the surface 10a and the surface 5a are preferably flush with each other. In that case, a possibility of shape failures of the catalyst layer 6, the second conductive layer 7, etc. can be avoided from occurring due to an unwanted level difference between the insulating portion 10 and the porous insulating layer 5.

In Embodiment 3, preferably, (refractive index n₁₀<refractive index n₄) is satisfied. In that case, the photoelectric conversion efficiency can be increased for the same reason as in Embodiment 2.

Furthermore, in Embodiment 3, at least part of the porous insulating layer 5, the part being positioned between the insulating portion 10 and the photoelectric conversion layer 4, preferably contains light scattering particles. The light scattering particles may be present in a state dispersed in the porous insulating layer 5

The light scattering particles may be made of a material having a refractive index different from that of the porous insulating layer 5. For example, titanium oxide or aluminum oxide is preferably used. The light scattering particles are preferably in the form of spheres with diameters of 300 to 1000 nm, for example. The word “spheres” used herein does not imply only exact spheres, and sphere surfaces may include irregularities. Other preferred shapes of the light scattering particles are, for example, a flake shape and an elliptic shape.

In Embodiment 3, since the above-described light scattering particles are contained in a region of the porous insulating layer 5 between the insulating portion 10 and the photoelectric conversion layer 4, the photoelectric conversion efficiency of the photoelectric conversion element can be further increased. The reason is as follows.

When (refractive index n₁₀<refractive index n₄) is satisfied and the light scattering particles are present in the region of the porous insulating layer 5 between the insulating portion 10 and the photoelectric conversion layer 4, part of the light traveling into the porous insulating layer 5 from the photoelectric conversion layer 4 impinges on surfaces of the light scattering particles, and the propagation direction of that light is scattered (refracted).

Because the propagation direction of the light incoming from the side including the first substrate 1 is scattered by the light scattering particles, a probability of the incident angle of the light at the interface between the photoelectric conversion layer 4 and the porous insulating layer 5 becoming larger than that when the light is not scattered increases. As the incident angle of the light at the interface is larger, the light reflection efficiency at the interface is higher. Consequently, the photoelectric conversion efficiency can be further increased.

The light scattering particles may be coated with an insulating material such as silica or zirconia. This is effective in suppressing reduction of a resistance value of the porous insulating layer 5, the reduction being caused with the presence of the light scattering particles. The light scattering particles may constitute one or more layers in the porous insulating layer 5 instead of being dispersed in the porous insulating layer 5.

Other points in Embodiment 3 than described above are similar to those in Embodiment 1 and Embodiment 2, and hence description of those points is not repeated.

### Embodiment 4

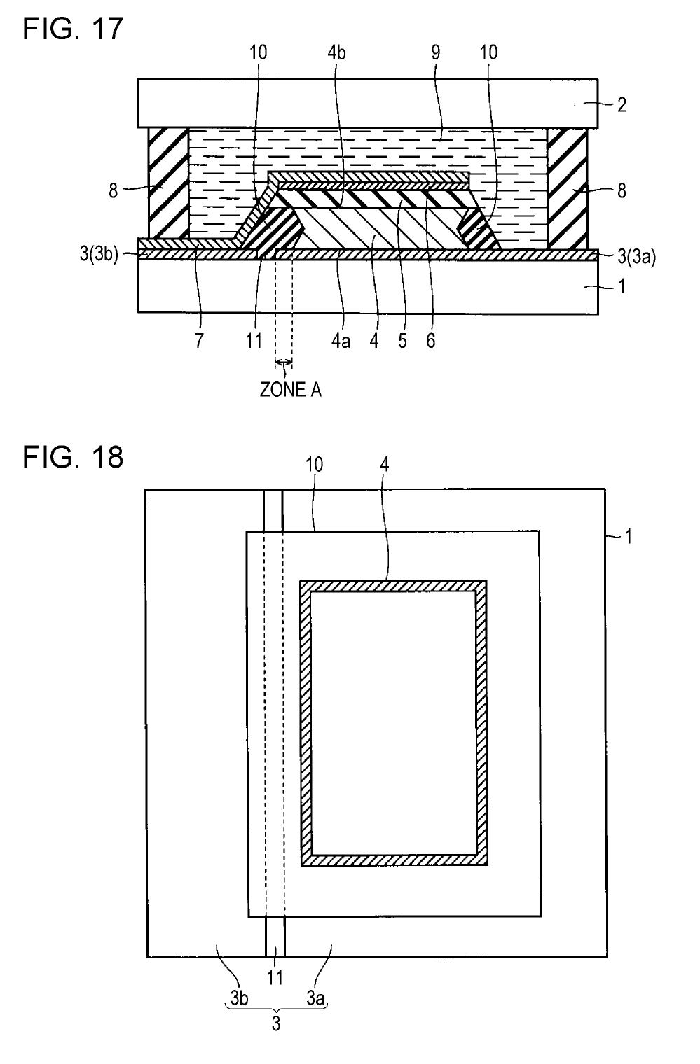

FIG. 17 is a schematic sectional view of a photoelectric conversion element of Embodiment 4, and FIG. 18 is a schematic plan view illustrating projection images when a photoelectric conversion layer and an insulating portion are projected onto a first substrate from the second substrate side in the photoelectric conversion element of Embodiment 4.

Referring to FIGS. 17 and 18, in Embodiment 4, an entire lateral surface of the photoelectric conversion layer 4 has a shape recessed toward the center side of the photoelectric conversion layer 4. In addition to having the configurations described in Embodiment 1, the insulating portion 10 is arranged to be contacted with the entire lateral surface (outer periphery) of the photoelectric conversion layer 4, and it has a shape projecting corresponding to the recessed shape of the photoelectric conversion layer 4.

Thus, the photoelectric conversion element of Embodiment 4 is different from the photoelectric conversion element of Embodiment 1 in that the insulating portion 10 arranged along only one side of the photoelectric conversion layer 4 near the groove 11 in Embodiment 1 is arranged along all four sides of the photoelectric conversion layer 4 in Embodiment 4.

In the photoelectric conversion element, the zone A, including the vicinity thereof, is generally deemed as a zone where the internal short-circuiting is most likely to occur. However, there is a fear that the internal short-circuiting attributable to misalignment in layouts of the individual components may occur at an outer periphery of the photoelectric conversion layer 4 as well. Embodiment 4 is able to suppress the internal short-circuiting that may occur at the outer periphery of the photoelectric conversion layer 4.

Other points in Embodiment 4 than described above are similar to those in Embodiment 1, and hence description of those points is not repeated.

### Embodiment 5

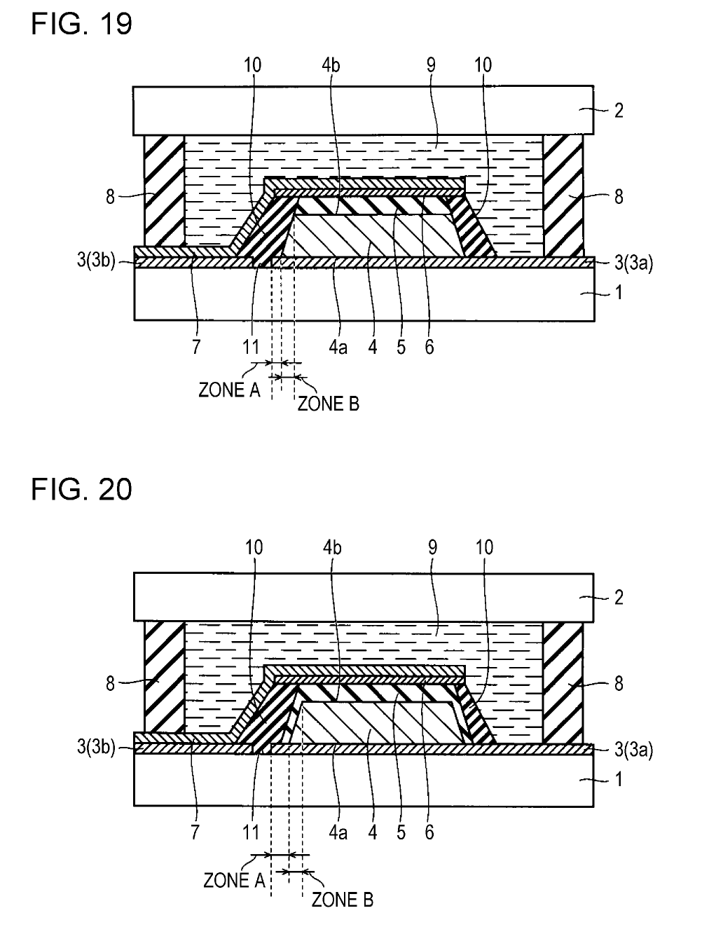

FIG. 19 is a schematic sectional view of a photoelectric conversion element of Embodiment 5. Referring to FIG. 19, the photoelectric conversion element of Embodiment 5 is different from the photoelectric conversion element of Embodiment 2 in that the insulating portion 10 arranged along only one side of the photoelectric conversion layer 4 near the groove 11 in Embodiment. 2 is arranged along all four sides of the photoelectric conversion layer 4 in Embodiment 5. Embodiment 5 is able to suppress the internal short-circuiting that may occur at the outer periphery of the photoelectric conversion layer 4.

Other points in Embodiment 5 than described above are similar to those in Embodiment 2, and hence description of those points is not repeated.

### Embodiment 6

FIG. 20 is a schematic sectional view of a photoelectric conversion element of Embodiment 6. Referring to FIG. 20, the photoelectric conversion element of Embodiment 6 is different from the photoelectric conversion element of Embodiment 3 in that the insulating portion 10 arranged along only one side of the photoelectric conversion layer 4 near the groove 11 in Embodiment 3 is arranged along all four sides of the photoelectric conversion layer 4 in Embodiment 6. Embodiment 6 is able to suppress the internal short-circuiting that may occur at the outer periphery of the photoelectric conversion layer 4.

Other points in Embodiment 6 than described above are similar to those in Embodiment 2, and hence description of those points is not repeated.

### Embodiment 7

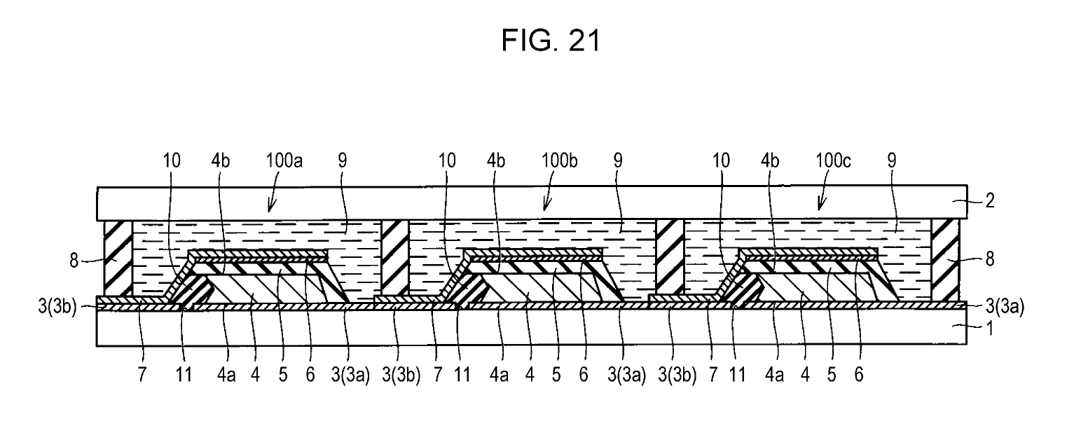

FIG. 21 is a schematic sectional view of a photoelectric conversion module of Embodiment 7. A structure of the photoelectric conversion module of Embodiment 7 is described with reference to FIG. 21.

The photoelectric conversion module of Embodiment 7 includes a plurality of photoelectric conversion cells 100a, 100b and 100c (100a to 100c), i.e., the plurality of photoelectric conversion elements of Embodiment 1. The photoelectric conversion cells 100a to 100c are partitioned into the individual cells by the sealing members 8. Each of the photoelectric conversion cells 100a to 100c includes, on and above the first substrate 1, the first conductive layer 3, the photoelectric conversion layer 4, the porous insulating layer 5, the catalyst layer 6, and the second conductive layer 7, and further includes the electrolyte 9 filled into the region surrounded by the first substrate 1, the second substrate 2, and the sealing member 8.

The first region 3a of the photoelectric conversion cell 100a is electrically connected to the second conductive layer 7 of the photoelectric conversion cell 100b, whereby the photoelectric conversion cell 100a and the photoelectric conversion cell 100b are electrically connected in series. Furthermore, the first region 3a of the photoelectric conversion cell 100b is electrically connected to the second conductive layer 7 of the photoelectric conversion cell 100c, whereby the photoelectric conversion cell 100b and the photoelectric conversion cell 100c are electrically connected in series. Thus, the photoelectric conversion cells 100a to 100c are connected in series.

Other points in Embodiment 7 than described above are similar to those in Embodiment 1, and hence description of those points is not repeated.

### EXAMPLES

### Example 1

The photoelectric conversion element of Embodiment 4, having the structure illustrated in FIGS. 17 and 18, was fabricated in accordance with the flowchart illustrated in FIG. 2.

(Step of Forming First Conductive Layer)

First, a glass substrate made by Nippon Sheet Glass Company, Ltd., coated with a SnO₂ film and having a surface in size of length 120 mm×width 420 mm, was prepared, and the SnO₂ film was partly linearly removed by laser scribing along a direction perpendicular to the serially connected direction. Thus, the groove 11 corresponding to a portion where the SnO₂ film was removed was formed in the shape of a stripe. As a result, the SnO₂ film serving as the first conductive layer 3 made up of the first region 3a and the second region 3b was formed in the shape of a stripe on the glass substrate serving as the first substrate 1.

(Step of Forming First Porous Semiconductor Layer)

Next, a commercially-available titanium oxide paste (made by Solaronix Co., Trade Name: Ti-Nanoxide D/SP, mean particle size: 13 nm) was coated over a region of the SnO₂ film, the region corresponding to the first region 3a, by employing a screen printing machine (made by NEWLONG SEIMITSU KOGYO CO., LTD., LS-34TVA).

A coating film obtained by leveling the titanium oxide paste at the room temperature for 1 hour was pre-dried at 80° C. for 20 minutes, and was then fired at 450° C. for 1 hour. The first porous semiconductor layer made of titanium oxide and having a thickness of 6 μm was formed by successively repeating the steps of coating, leveling, pre-drying, and firing the titanium oxide paste in the mentioned order.

(Step of Forming Insulating Portion)

Next, a glass paste containing a glass frit (made by Asahi Glass Company, Ltd., glass transition temperature: 450° C., softening point: 510° C.) was applied to a position corresponding to the insulating portion 10 by employing the screen printing machine (made by NEWLONG SEIMITSU KOGYO CO., LTD., LS-34TVA). A coating film obtained by leveling the glass paste at the room temperature for 1 hour was pre-dried at 80° C. for 20 minutes, and was then fired at 540° C. for 1 hour. With the above-described forming method, because the glass paste was solidified after being fused, the insulating portion having a smaller void ratio than the porous insulating layer, which is to be formed later, was formed.

(Step of Forming Second Porous Semiconductor Layer)

Next, the second porous semiconductor layer made of titanium oxide and having a thickness of 6 μm was formed in a step similar to the above step of forming the first porous semiconductor layer. The porous semiconductor layer made up of the first porous semiconductor layer and the second porous semiconductor layer constitutes the base of the photoelectric conversion layer 4.

(Step of Forming Porous Insulating Layer)

Next, a paste containing zirconium-oxide fine particles (made by C.I. Kasei CO., LTD., melting point: 2700° C.) with a particle size of 100 nm was prepared by a similar method to that described above. The prepared paste was coated over the porous semiconductor layer by employing the same screen plate and screen printing machine (made by NEWLONG SEIMITSU KOGYO CO., LTD., LS-34TVA) as those used in fabricating the porous semiconductor layer. After leveling the coated paste at the room temperature for 1 hour was pre-dried at 80° C. for 20 minutes, and was then fired at 450° C. for 1 hour. The porous insulating layer 5 with a thickness of 5 μm was formed on the porous semiconductor layer in the above step.

(Step of Forming Catalyst Layer)

Next, the catalyst layer 6 made of a platinum film with a thickness of 5 nm was formed on the porous insulating layer 5 by vapor-depositing platinum at a deposition rate of 0.1 Å/S with an electron beam deposition apparatus EVD-500A (made by ANELVA Company).

(Step of Forming Second. Conductive Layer)

Next, the second conductive layer 7 made of a Ti film with a thickness of 2 μm was formed on the catalyst layer 6 by vapor-depositing titanium (Ti) at a deposition rate of 0.1 Å/S with the electron beam deposition apparatus EVD-500A (made by ANELVA Company).

(Step of Adding Photosensitizer)

Next, Ruthenium 620-1H3TBA dye (made by Solaronix Co.) was used as the sensitizer dye. A 1:1-solution of acetonitrile (made by Aldrich Chemical Company)/t-butylalcohol (made by Aldrich Chemical Company), the solution containing the sensitizer dye (concentration of the sensitizer dye; 4×10⁻⁴ mol/liter), was prepared. The porous semiconductor layer was immersed in the solution and left to stand for 20 hours under a temperature condition of 40° C. Thereafter, the porous semiconductor layer was washed with ethanol (made by Aldrich Chemical Company) and then dried. Thus, the photoelectric conversion layer 4 was formed on the first conductive layer 3 by adsorbing the sensitizer dye on and in the porous semiconductor layer.

(Step of Injecting Electrolyte)

Next, an ultraviolet curable resin (TB3035B (made by ThreeBond Co., Ltd.) was prepared as the precursor of the sealing member 8, and was applied onto the first conductive layer 3 around a multilayer body of the photoelectric conversion layer 4, the porous insulating layer 5, the catalyst layer 6, the second conductive layer 7, and the insulating portion 10, which were laminated as described above.

Next, the second substrate 2 in the form of a glass substrate was placed on a surface of the precursor of the sealing member 8 in an opposing relation to the first substrate 1, and the first substrate 1 and the second substrate 2 were bonded to each other.

Next, the electrolyte 9 was prepared as a redox electrolyte solution obtained by employing acetonitrile as a solvent, and dissolving 0.6 mol/liter of 1,2-dimethyl-3-propylimidazolium iodide (made by SHIKOKU CHEMICALS CORPORATION), 0.1 mol/liter of LiI (made by Aldrich Chemical Company), 0.5 mol/liter of 4-tert-butylpyridine (made by Aldrich Chemical Company), and 0.01 mol/liter of I₂ (made by Tokyo Chemical Industry Co., Ltd.). The electrolyte 9 was then injected into a space formed between the first substrate 1 and the second substrate 2 and partitioned by the sealing member 8 through holes that were previously formed in the second substrate 2 for injection of the electrolyte 9. The photoelectric conversion element of EXAMPLE 1 was fabricated through the above-described steps.

In EXAMPLE 1, when the photoelectric conversion layer 4 and the insulating portion 10 were projected onto the first substrate 1 from the side including the second substrate 2, the projection images of the insulating portion 10 and the photoelectric conversion layer 4 overlapped with each other as illustrated in FIG. 18. Widths of overlapped regions between both the images were 200 μm (namely, the overlapped regions along four sides were the same).

### Comparative Example 1

The photoelectric conversion element illustrated in FIG. 12 was fabricated by a similar method to that in EXAMPLE 1 except that the porous semiconductor layer made of titanium oxide and having a thickness of 12 μm was formed in the step of forming the first porous semiconductor layer without performing both the step of forming the second porous semiconductor layer and the step of forming the insulating portion.

<Evaluation>

Fifty-two photoelectric conversion elements were prepared for each of EXAMPLE 1 and COMPARATIVE EXAMPLE 1, and the occurrence of the internal short-circuiting was checked using a tester. More specifically, probes of the tester were brought into contact with the first region 3a and the second region 3b of the first conductive layer 3, and resistance between both the regions was measured. As a result, resistances values of several tens MΩ or more were measured in all the photoelectric conversion elements of EXAMPLE 1. Regarding the photoelectric conversion elements of COMPARATIVE EXAMPLE 1, however, resistance values of about several tens kΩ were measured in twelve elements, and resistance values of several tens Ω were measured in forty elements.

From the above measurement results, it was confirmed that the internal short-circuiting was suppressed in all the photoelectric conversion elements of EXAMPLE 1. On the other hand, among the fifty-two photoelectric conversion elements of COMPARATIVE EXAMPLE 1, the forty elements had resistance values of about several tens Ω, and were regarded as causing the internal short-circuiting. Furthermore, among the photoelectric conversion elements of COMPARATIVE EXAMPLE 1, the twelve elements (having resistance values of several tens kΩ) were regarded as not causing the internal short-circuiting, but it was confirmed that the resistance values were lower than those in the photoelectric conversion elements of EXAMPLE 1.

[Supplemental Statement]

(1) In the photoelectric conversion elements according to Embodiments disclosed herein, preferably, the insulating portion and the photoelectric conversion layer have surfaces opposing to the second substrate, and those opposing surfaces are included in the same plane.
(2) in the photoelectric conversion elements according to Embodiments disclosed herein, preferably, the insulating portion and the porous insulating layer have surfaces opposing to the second substrate, and those opposing surfaces are included in the same plane.

While Embodiments and EXAMPLE have been described above, it is also supposed, as a matter of course, to combine the above-described configurations of Embodiments and EXAMPLES with each other as appropriate.

Embodiments and EXAMPLES disclosed herein are to be considered as illustrative and not restrictive in all respects. The scope of the present invention is defined by Claims and not by the above description. Modifications equivalent to the meaning of Claims and falling within the scope defined by Claims are all included in the present invention.

### INDUSTRIAL APPLICABILITY

Embodiments and EXAMPLES disclosed herein can be applied to a photoelectric conversion element and a photoelectric conversion module each having the so-called monolithic structure. They can be applied to, particularly, a dye-sensitized solar cell and a dye-sensitized solar cell module.

### REFERENCE SIGNS LIST

1 first substrate
2 second substrate
3 first conductive layer
3a first region
3b second region
4 photoelectric conversion layer
4a first surface
4b second surface
5 porous insulating layer
6 catalyst layer
7 second conductive layer
8 sealing member
9 electrolyte
10 insulating portion
11 groove
5a and 10a surfaces
100a, 100b and 100c photoelectric conversion cells

1. A photoelectric conversion element comprising:
a first substrate;
a second substrate opposing to the first substrate with a space formed therebetween;
a first conductive layer positioned on the first substrate;
a photoelectric conversion layer positioned on the first conductive layer;
a porous insulating layer positioned on the photoelectric conversion layer;
a second conductive layer positioned on the porous insulating layer;
a sealing member surrounding a region between the first substrate and the second substrate; and
an electrolyte filled into the region surrounded by the first substrate, the second substrate, and the sealing member,
wherein the photoelectric conversion layer includes a porous semiconductor layer and a photosensitizer added to the porous semiconductor layer,
the first conductive layer is divided by a groove into a first region where the photoelectric conversion layer is arranged, and a second region where the photoelectric conversion layer is not arranged,
an insulating portion is arranged in and above the groove in a covering relation to a surface of the first region in part thereof where the photoelectric conversion layer is not arranged,
the insulating portion has a denser structure than the porous insulating layer, and
when the photoelectric conversion layer and the insulating portion are projected onto the first substrate from side including the second substrate, a projection image of the insulating portion partly overlaps a projection image of the photoelectric conversion layer.

2. The photoelectric conversion element according to claim 1, wherein the insulating portion has a smaller refractive index than the photoelectric conversion layer.

3. The photoelectric conversion element according to claim 1, wherein part of the porous insulating layer is positioned between the insulating portion and the photoelectric conversion layer, and contains light scattering particles.

4. The photoelectric conversion element according to claim 1, wherein the photoelectric conversion layer has a first surface opposing to the first substrate, and a second surface opposing to the second substrate, and
when the first surface, the second surface, and the insulating portion are projected onto the first substrate from the side including the second substrate, a projection image of the second surface is matched with or included in a projection image of the first surface, and the projection image of the insulating portion partly overlaps the projection image of the second surface.

5. A photoelectric conversion module including the photoelectric conversion element according to claim 1.

6. The photoelectric conversion element according to claim 1, wherein
the insulating portion is at least one selected from a group consisting of a silicone resin, an epoxy resin, a polyisobutylene resin, a hot-melt resin and a glass frit.

7. The photoelectric conversion element according to claim 1, wherein
the photoelectric conversion layer comprises two or more porous semiconductor layers,
a first porous semiconductor included in the two or more porous semiconductor are covered by the insulating portion, and
a second porous semiconductor included in the two or more porous semiconductor covers the insulating portion.

8. The photoelectric conversion element according to claim 1, wherein
the photoelectric conversion layer comprises
a porous semiconductor layer and
a photosensitizer put on surfaces inside and outside pores in the porous semiconductor layer; and
the porous semiconductor is at least one selected from a group consisting of titanium oxide, zinc oxide, tin oxide, iron oxide, niobium oxide, cerium oxide, tungsten oxide, barium titanate, strontium titanate, cadmium sulfide, lead sulfide, zinc sulfide, indium phosphide, copper-indium sulfide (CuInS₂), CuAlO₂, and SrCu₂O₂.

9. The photoelectric conversion element according to claim 8, wherein
the photoelectric conversion layer comprises
a porous semiconductor layer and
a photosensitizer put on surfaces inside and outside pores in the porous semiconductor layer; and
the porous semiconductor is at least one selected from a group consisting of titanium oxide, zinc oxide, tin oxide, iron oxide, niobium oxide, cerium oxide, tungsten oxide, barium titanate, strontium titanate, cadmium sulfide, lead sulfide, zinc sulfide, indium phosphide, copper-indium sulfide (CuInS₂), CuAlO₂, and SrCu₂O₂.

10. The photoelectric conversion element according to claim 1, wherein
the porous insulating layer positioned on the photoelectric conversion layer and the insulating portion.
